(19) United States
(12) Patent Application Publication
(10) Pub. No.: US 2014/0013116 A1
(43) Pub. Date: Jan. 9, 2014

(54) APPARATUS AND METHOD FOR PERFORMING OVER-THE-AIR IDENTITY PROVISIONING

(71) Applicants: Ned M. Smith, Beaverton, OR (US); Sanjay Bakshi, Portland, OR (US)

(72) Inventors: Ned M. Smith, Beaverton, OR (US); Sanjay Bakshi, Portland, OR (US)

(73) Assignee: Intel Corporation, Santa Clara, CA (US)

(21) Appl. No.: 14/006,525

(22) PCT Filed: Dec. 30, 2011
(86) PCT No.: PCT/US11/68050

§ 371 Date: Sep. 20, 2013

(51) Int. Cl. H04W 12/08

(52) U.S. Cl. CPC H04W 12/08
USPC 713/168; 726/4

(57) ABSTRACT

A method for controlling access to information includes sending a request from an identity requester to an identity provider through an over-the-air (OTA) link. Data received from the identity provider in response to the request includes information used to establish a first identity of a user for a first service. The first identity information is received during a Sigma session, and a second identity of the user is established for a second service based on the received first identity information. The user may be a user of a mobile communication terminal or other device, which is to receive the first and second services.

### FIELD

One or more embodiments herein relate to electronic information management.

### BACKGROUND

Establishing the identity of a user is a pre-requisite to receiving many types of network services. This has been performed manually by having a user fill out information on a form, by providing information over the phone, and/or by entering information using a website. These techniques have proven costly and inefficient.

Recently, efforts have been made to automate the process of establishing the identity of a user, as a requirement for receiving network services. These efforts have included receiving information over a wireless network to establish user identity. Because the information is received wirelessly, this technology has often been referred to as Over-the-Air (OTA) identity provisioning.

Existing OTA identity provisioning techniques are inefficient in terms of the manner in which user credentials are obtained and authenticated. Moreover, these techniques attempt to establish identity independently from other sources or domains which have already authenticated and established an identity for the user.

### BRIEF DESCRIPTION OF THE DRAWINGS

FIG. 1 shows a system for performing over-the-air (OTA) identity provisioning.

FIG. 2 shows an embodiment of a method for establishing an OTA identity based on an existing identity established for a device user.

FIG. 3 shows an example of first identity credentials in an identity provider.

FIG. 4 shows one embodiment of an identity requester.

FIGS. 5 to 8 show another method for performing OTA identity provisioning.

FIG. 9 shows another embodiment of a system for performing OTA identity provisioning, in which the identity requester is located within the electronic device

FIG. 10 shows an exchange of messages that may take place to implement a Sigma session between the identity provider and requester.

### DETAILED DESCRIPTION

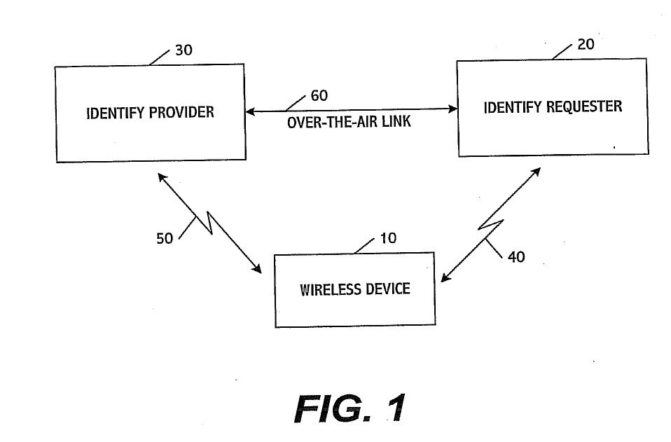

FIG. 1 shows an example of a system in which OTA identity provisioning is performed in accordance with one embodiment. In this embodiment, the user of a wireless device 10 seeks to obtain one or more services, goods, or information from a provider. The wireless device may be a mobile or smart phone, notebook or desktop computer, personal digital assistant, pod- or pad-type device, tablet, or any one of a number of other electronic devices equipped with wireless capability. The embodiments described herein may pertain to mobile devices. However, in other embodiments devices considered to be fixed or transportable may also be subject to the methods and systems described herein.

The identity provider may provide financial services, media or entertainment services, communication services, internet-related services, and/or other services from private or corporate/business sources. According to one example, the user of the electronic device may hold a subscription or other committed form payment or membership with the source or service. Before the provider can supply the services, the provider must establish a trusted identity of the user. For this reason, the provider is described as an identity requester 20 in FIG. 1.

In accordance with this embodiment, the identity requester establishes an identity for the user of the electronic device based on an identity that has already been established by another provider. The other provider, thus, provides information indicative of its already-established identity for use by the identity requester 20. The other provider is therefore described within the context of FIG. 1 as an identity provider 30, with the understanding that both the requester 20 and provider 30 are actually providers.

The identity provider 30 may provide a financial service, media or entertainment service, communications service, internet-related service, and/or a variety of other services to the user. According to one example, the identity provider may be a retailer, utility, government entity or other type of private, corporate, or business source that provides goods and/or services and/or information sought by the user and for which establishment and authentication of identity is required.

The wireless device 10 may communicate with the identity requester 20 over a wireless link 40, which, for example, may be established through one or more mobile networks or a short-range link connected to a wired or wireless network such as but not limited to the Internet. The device may also be in communication with the identity provider 30 over the same type of link.

Alternatively, the identity provider may not be in direct communication with device 10, but rather may merely hold the identity of the user of this device in a way unrelated to use of the device. For example, the identity provider may be a credit card company, bank, financial advisor, broker, insurance company, or other financial institution. In this case, the identity provider 30 may have access to a database that is made accessible by the identity requester 20 as described in greater detail below.

The identity requester 20 and provider 30 communicate with one another through an over-the-air link 60. In accordance with one embodiment, the information exchanged between the identity requester and provider may occur in a manner transparent to the user based on control software stored. Using the exchanged information, the identity requester authenticates and establishes an identity for the user in its own domain, thereby alleviating the need for manual or other costly and inefficient data input. Because link 60 is established transparent to the user, it may be described as a “back channel” for some applications.

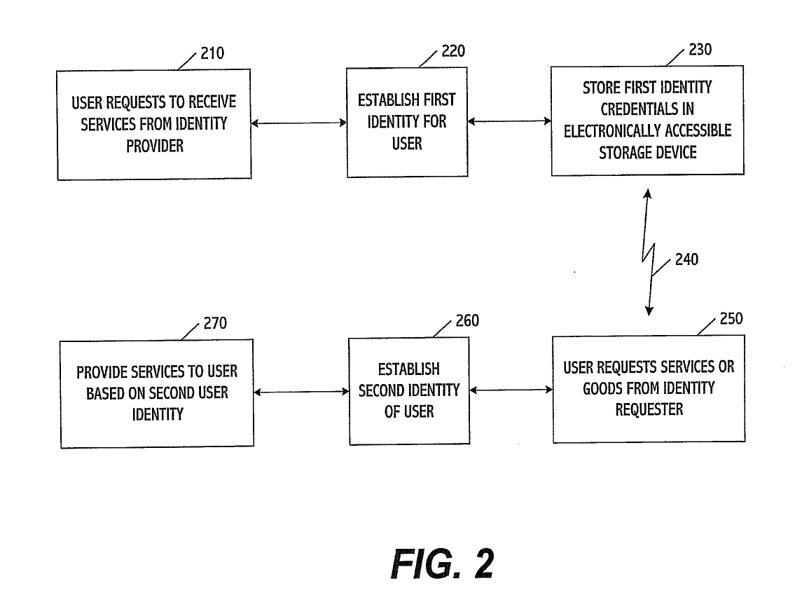

FIG. 2 shows one embodiment of a method for establishing an OTA identity based on an existing identity established for a mobile device user. This method may be implemented in a system such as shown in FIG. 1 or a different system. Control software located, at least in part, within the identity provider and requester may be used to implement the method.

### Establishing First Identity

An initial operation includes receiving a request 210 from the user of the mobile device to receive a service from the identity provider. For illustrative purposes, it will be assumed for this embodiment that the service is based on a subscription. However, in other embodiments, other goods and/or services may be covered. The request may be received, for example, over the phone, in person, through a request made over the internet, or in a store as well as other ways including a request made wirelessly from the device.

Once the request has been made, the identity provider establishes an identity 220 (referred to as a first identity) for the user for purposes of establishing the subscription. The identity may be established using conventional techniques. For example, as indicated, the user's identity may be based on user information entered manually or otherwise and may include a date-of-birth, address, social security number, credit card or account number, as well as other information that constitutes a reliable basis from which the user's identity may be confirmed. These techniques may be referred to as “out-of-band” subscription or identity-determination techniques.

Once the user has been authenticated and his identity established, first identity credentials 230 are stored in an electronically accessible database or other storage device. These credentials are based on the user information described above and are relied on as a basis for establishing a second identity for the user.

### Establishing Second Identity

After the first identity credentials are stored, the user requests a subscription to receive services 250 from the identity requester. The request may be made directly from the mobile device 10, for example, over a wireless network. Alternatively, the request may be made through an internet website accessed on the user's mobile device. In accordance with one example, the request is made pursuant to a request for a subscription to a service, membership to website, on-line purchase, or in another context.

According to one specific example, in making the request, a user may access a webpage of the identity provider that includes a selectable option for creating a user account. The account may be created based on a user name, password and answers to security questions, as well as other information. In another example, a user may provide initiate transfer of information encrypted, for example, based on a public key infrastructure (PKI) key. The information may be transferred, for example, based on transmission of a certificate request message, which may be used by a certificate authority to construct a digital certificate for the user and/or his device.

Once the request is made, the identity requester performs a procedure which includes automatically establishing a link (e.g., OTA back channel connection) for receiving information from the storage device containing the first identity credentials of the user. Because the first identity credentials are stored in a database or storage device of the identity provider, the aforementioned procedure may require the link to be established with the identity provider.

In order to establish the link, the identity requester determines the existence and contact in formation of the identity provider 30 based on, for example, a utility tool. More specifically, a user may manage his identities using a utility tool such as a password manager, which has web integration features in which Universal Resource Locator (URL) prompting for a user name/password is redirected to the password manager for auto completion/form fill-in.

In accordance with one embodiment, the manager tool may detect that a new user identity is to be created. Rather than prompting the user to create a new user name and password, the user may be given an alternative choice to constructed a new identity (e.g., user name and password) based on information corresponding to the first user identity, which, for example, may include a user name, digital certificate, and/or other information for identifying the user.

In the case of a user name and password, the password manager may store information to recall the website URL (e.g., for auto-fill-in purposes). This URL may then be used to construct an identity-reuse request. If the identity is or includes a certificate, the certificate may contain issuer contact information such as an issuer RDN and issuer URL, with the issuer corresponding to identity provider 30. Based on this information, the identity requester may establish the link for receiving the first identity credentials.

Once the link is established, he first identity credentials are sent to the identity requester for use in establishing a second identity 260 for the user, in order to allow the user to receive the subscription offered by the identity requester. The identity requester may contact the identity provider, for purposes of receiving the first identity credentials, over the back channel previously described. As indicated, this may take place automatically (e.g., in response to the user request for the subscription) and in a manner transparent to the user.

Once received, the identity provider authenticates the user based on the first identity credentials and then establishes the second identity based on this information. According to one example, the first identity may include a user name, password, and/or a digital certificate. Also, the first and second identities may be the same or may be different from one another, e.g., a different user name and password. In the case that the first identity is a digital certificate, the second identity to be established a different certificate may be created based on, for example, performance of an enrollment process with a different certificate authority.

Because the request for the subscription (or other service) from the identity requester is made wirelessly and/or the information obtained from the identity provider is obtained wirelessly over a link which includes a mobile network, the procedure for establishing the second identity may be described as over-the-air (OTA) identity provisioning. (Thus, the back channel between the identity requester and provider may be referred to as an OTA connection.) Once the second identity has been established, the services 270 may be provided to the user on his or her mobile device based on the second identity.

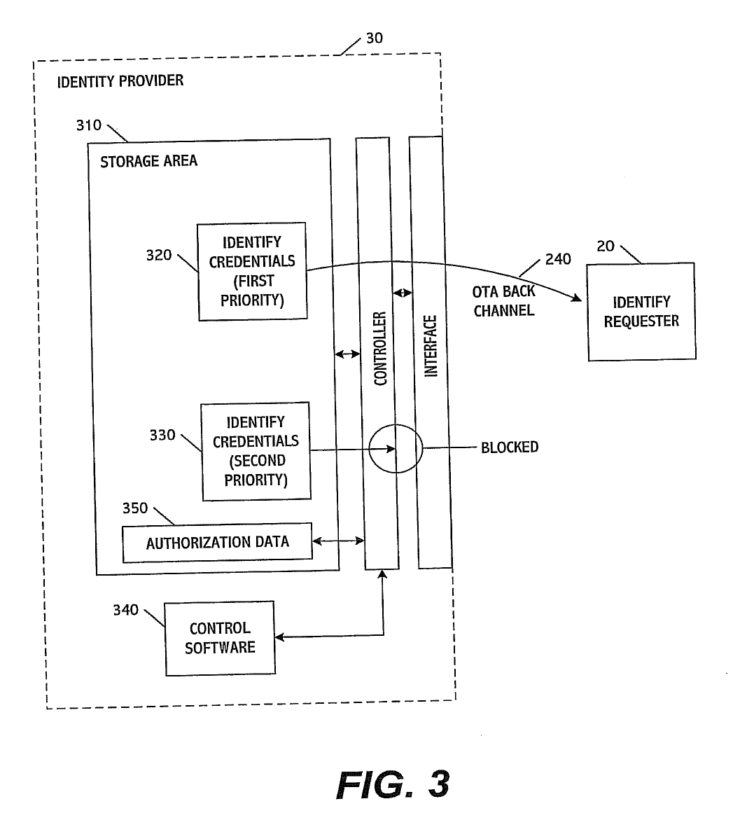

FIG. 3 shows an example of how the first identity credentials may be classified and how those credentials are transferred to the identity requester. In order to transfer these credentials, the identity requester 20 establishes an OTA back-channel 240 to the identity provider 30. The link may be automatically established based, for example, on a request-for-information (RFI) signal transmitted from the identity requester to the identity provider.

In order to send the RFI signal, the identity requester must first identify the identity provider and corresponding address information. This may be accomplished, for example, based on a downloaded application to be executed in the mobile device or by an executable file stored on the mobile device, for example, when read from a compact disk (CD) or digital versatile disk (DVD). When executed, the application or file may automatically establish a connection to the identity provider for purposes of obtaining the credentials necessary for establishing the second user identity.

Once the RFI signal is received through interface 330, a processor guided by control software 340 in the identity provider 30 controls output of one or more first identity credentials from storage device 310, which, for example, may be a subscriber database, memory, or other storage area. In accordance with one embodiment, only one or more selected credentials may be provided to the identity requester.

For example, consider the case where the first identity credentials are classified to include public credentials 320 and private credentials 330. The public credentials may correspond to, for example, an address, telephone number, e-mail address, and/or other publicly known information relating to the user. The private credentials may include credit card information, social security number, passwords and/or user names, and/or other private information.

In order to authenticate the user and thus to establish the second identity, the private credentials may not be necessary. Moreover, the user may wish to block access to this information to other entities without express permission, on a case-by-case basis. Under these circumstances, the public credentials 320 may be transmitted to the identity requester over the back channel and the private credentials may be blocked from being transmitted, based on control software of the identity provider governing the transfer of private credentials.

Alternatively, or additionally, the decision to block transfer of the private credentials may be made based on one or more user settings stored in the identity provider and/or based on information in the RFI signal.

Blocking transfer of the private credentials may serve two purposes.

First, blocking transfer of private credentials protects the user's identity from fraud, which has become increasingly important for communications taking place over a network.

Second, blocking the private credentials allows the authenticity of the second identity to be confirmed based on the fact that the user identity was previously confirmed by the identity provider. If the identity provider is reputable, a second independent confirmation of the identity of the user may not be needed. This, in turn, will make the process of establishing the second identity more efficient in terms of processing speed and user convenience.

In an alternative embodiment, the private credentials may be transmitted to the identity requester in encrypted form and/or using some other secure method of information protection. The same may be performed for the public credentials even though this information may be considered to be less sensitive than the private credentials.

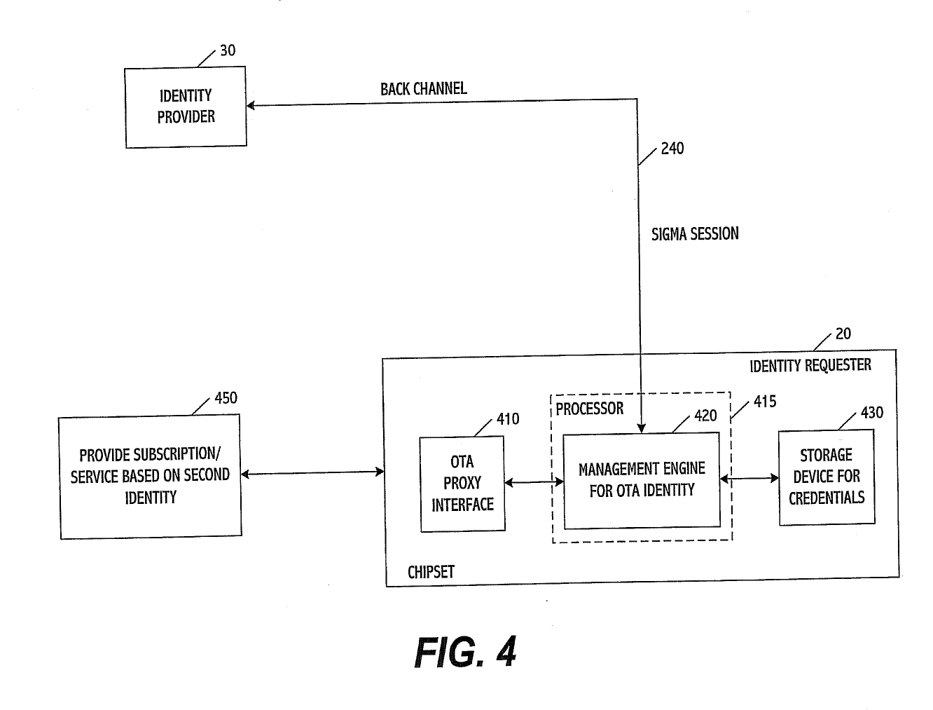

FIG. 4 shows one embodiment of the identity requester, which is equipped to implement a trusted client applet to establish a secure OTA connection to the identity provider. As shown, the identity requester includes an OTA proxy interface 410, a processor 415 including a management engine 420 for performing operations for establishing the OTA connection and second user identity as well as performing other processing and management functions, and a storage device 430 to store credentials for establishing the second user identity.

The OTA proxy 410 may operate to provide network connectivity and may be used in the event the management engine does not have direct network access. According to one embodiment, the OTA proxy operates as an interface for relaying signals in a mobile communication system based on a predetermined standard or protocol. In this embodiment, the proxy may control communications between the identity requester and the identity provider through the OTA back-channel connection. The proxy may be implemented as chipset firmware to be executed by the management engine/controller, and may or may not reside outside the trust boundary of the engine.

In other embodiments, the management engine may have direct access to a communications network and/or a communications hub. In this scenario, the proxy may be considered an optional feature, as the management engine may establish the OTA back channel connection apart from a proxy.

The management engine 420 executes an OTA applet (or other type of application) which establishes the OTA back-channel connection to the identity provider. This connection may be established during a Sigma session in the identity provider and requester. More specifically, the OTA connection may be established using a Sigma protocol with attestation. A predetermined identity attribute disclosure policy governing the transfer of credentials from the identity provider to the identity requester may be implemented by the identity provider. Such a policy (implemented in software) may allow public credentials to be transferred and private (or a more sensitive hierarchy of) credentials to be transferred to the identity requester.

The management engine receives the credentials (which may or may not be encrypted) from the storage device of the identity provider over the OTA back-channel connection as previously explained, and then stores these credentials in storage device 430. The management engine then establish the second user identity based on the stored credentials and provides the subscription and/or service to the user device based on the established second identity 450. In this way, the management engine may be considered to operate as a trusted service manager within a secured environment. In accordance with one embodiment, the OTA proxy, management engine, and/or storage device may be located in a server of the identity requester.

According to one example, the management engine may be implemented by a controller in a chipset included in the identity requester. This engine may operate as a secure element, with a hardened security boundary that runs trusted code. In running this code, both the identity provider and requester may trust to function for purposes of transferring the first identity from the identity provider to the identity requester pursuant to, for example, transmission of the RFI signal previously discussed.

The RFI signal from the identity requester may be generated by a management engine applet that operates to identity a provider for which an identity has already been established and stored information providing information for linking the identity requester to this identity provider. In performing this function, the applet may direct the controller to select a provider that has established an existing identity that approximates, if possible, identity credentials required to establish the second identity for the identity requester. The identity requester may also verify that the identity provider has authorized disclosure of credentials corresponding to the first identity, in a manner described herein.

Consider, for example, the case where the identity provider is Amazon.com (which maintains a database of first user identity credentials) and the identity requester is a video-on-demand (VOD) website. In this scenario, the management engine performs the role of a trusted third party that allows Amazon.com and the VOD entity to connect to one another using a utility tool. The tool may access connection information (e.g., URL) for Amazon.com (e.g., stored in a memory coupled to the management engine) that allows the OTA back channel link to be established. Then, based on operations performed by the management engine, first identity credentials may be sent from Amazon.com to the VOD entity for establishing the second identity for the VOD entity.

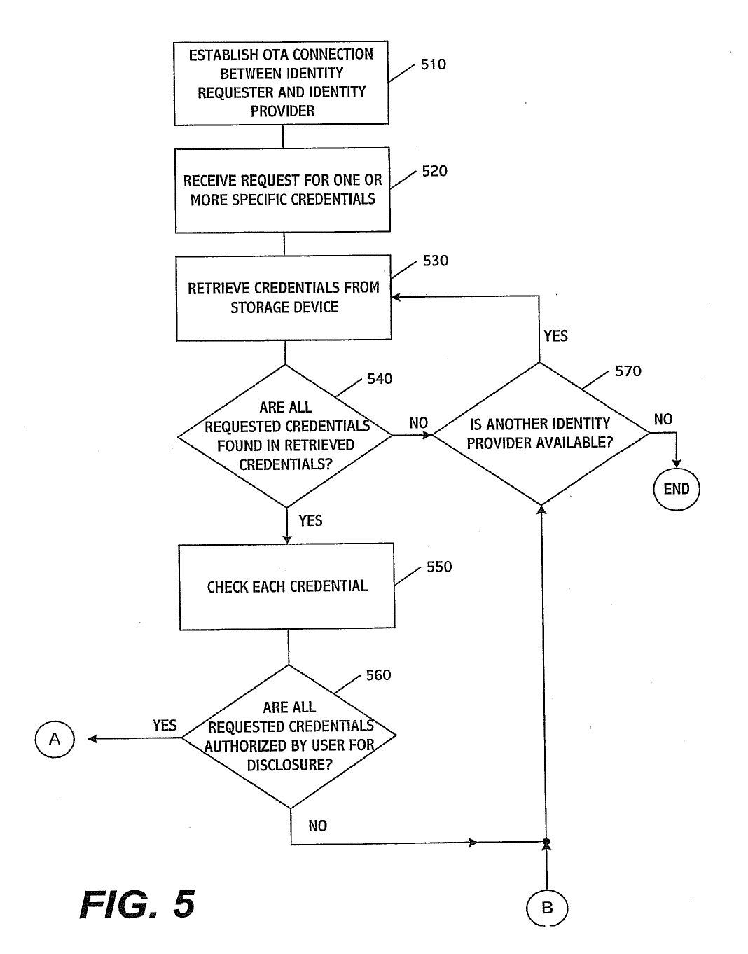

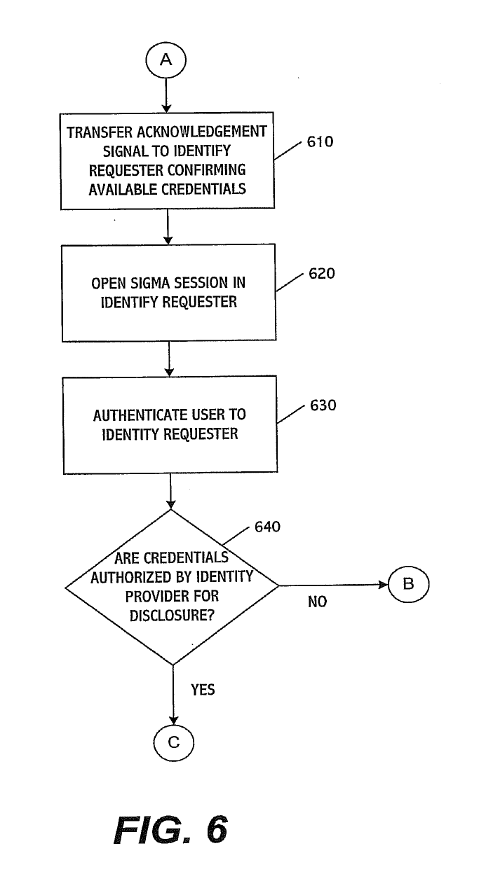

FIGS. 5 to 8 show operations included in a more detailed embodiment of a method for performing OTA identity provisioning. This method includes establishing an OTA connection between an identity requester and identity provider. (Block 510). The identity requester and provider may be those previously discussed, and the OTA connection may be considered to be any of the types connections previously discussed including but not limited to a back-channel connection.

The OTA connection may be initiated by the identity requester, for example, in response to a signal received from the electronic device 10 shown in FIG. 1 or when otherwise notified. The signal or other notification may be received based on control of an application running on the electronic device or may be initiated at a later time based on information received from the user over a wired or wireless link.

After the connection has been established, the identity provider receives a request for one or more specific credentials from the identity requester. (Block 520). The credentials may be any of those previously identified. In response to the request, the identity provider retrieves credentials from a storage area corresponding to the user. The credentials may be all or a portion of the specific credentials identified in the request. The storage area may be located within a server of the identity provider or remotely coupled thereto. (Block 530).

Once retrieved, a determination is made as to whether all the credentials identified in the request are found in the retrieved credentials. (Block 540). If yes, the each credential is to be checked. (Block 550). This operation focuses on the permissions or disclosure policy to be observed in providing the credentials to the identity requester.

For example, each credential (e.g., name, phone number, account number, signature bits signed by one or more keys of the identity provider, etc.) may have different uniqueness and sensitivity properties. Thus, some credentials may be acceptable to disclosure, while others are unacceptable given the user's trust in the identity provider. In order to protect disclosure of unwanted information, the identity provider may observe the user's permissions (e.g., based on stored information) in controlling the negotiation of the credentials to be disclosed. The transfer of credentials that are permissible to be disclosed are sent during a Sigma session, which provides an added measure of security against unwanted or unintended disclosure.

If no, then it is concluded that the identity provider cannot be used for purposes of establishing the second user identity for the requester. In this case, a determination is made by the identity requester as to whether another identity provider may be used or is available for establishing the second user identity. The identity established by this other provider may be one previously established. (Block 570).

If another identity provider is determined to exist, Block 530 and subsequent blocks are repeated for that other identity provider. Otherwise, the method may end, e.g., the user's identity must be established according to conventional methods.

After the operation in Block 550 is performed, a determination is made as to whether all credentials identified in the request are authorized for disclosure by the user. (Block 560). This determination is made by the identity provider, for example, based on a setting or permission information previously provided by the user and now stored in the identity provider. If all the requested credentials are not authorized by the user for disclosure to the identity requester (for example, because some of them are private credentials that are not authorized for transfer to another entity as previously discussed), then process flow continues to Block 570 to locate, if possible, another identity provider.

If all the requested credentials are authorized by the user for disclosure (e.g., are all public credentials or include private credentials that the user has previously authorized for disclosure), then an acknowledgment signal is sent from the identity provider to the identity requester over the OTA connection to confirm availability of the credentials. (Block 610). This signal may be generated by the management engine for transmission along the OTA connection.

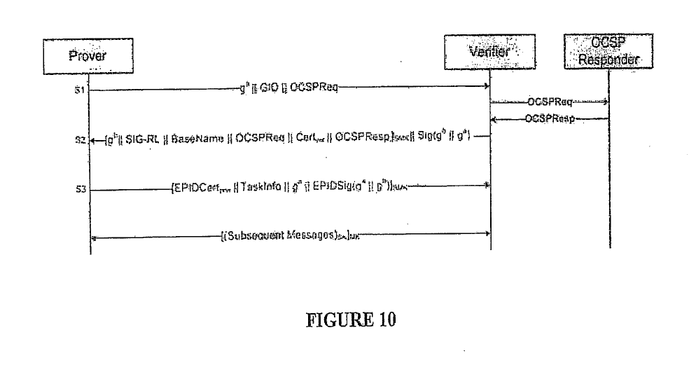

After the acknowledgment signal is received, the management engine in the identity requester opens a Sigma session for the purpose of creating the second user identity. (Block 620). According to one exemplary embodiment, the Sigma session may be performed based on a Sigma key exchange protocol. In implementing this protocol, two session keys MK and SK may be used. One of these keys (MK) is used to protect confidentiality and the other key (SK) is to protect the integrity of messages to be exchanged between the identity provider and requester. During the session, the identity requester may prove to the identity provider that the identity requester is a trustworthy secure element. This may be accomplished, for example, based on a TASKINFO signal which describes precisely the firmware configuration of the secure element, while EPID provides that the client side of the link is specific (e.g., Intel Corporation) hardware. FIG. 10 shows an example of messages that may be exchanged in implementing the Sigma session.

After the Sigma session has been opened, the management engine in the identity requester performs a procedure to authenticate the user. (Block 630). In performing this procedure, it is understood that the credentials may describe the user and are trusted to have originated from a secure element of the user, as maintained in or by the identity provider. Thus, authentication may be based on the establishment of an identity for the user by the identity provider, and also in accordance with the messages exchanged during the Sigma session as previously explained.

After the user has been authenticated, a determination is made as to whether the credentials are authorized by the identity provider for disclosure. (Block 640). This may be performed based on a policy implemented by a controller (e.g., which may or may not be similar to management engine 420) in the identity provider. This policy may direct the controller to tag which credentials are sensitive (e.g., of higher priority and/or which are unauthorized for disclosure). Additionally, or alternatively, the Sigma session and OTA back channel connection may be used to perform a query on a per attribute basis. A sample of pseudo code to implement the authorization may be given as follows wherein domain B corresponds to the identity requester:
Given User-1, Assert:
   OK to disclose Attr-A to Domain-B (yes/no)
   OK to disclose Attr-B to Domain-B (yes/no)
      If the credentials are not authorized by the identity provider for disclosure, then the operation in Block 570 is performed to determine whether another identity provider is available for purposes of establishing the second identity. On the other hand, if the credentials are authorized by the identity provider for disclosure, then a determination is made as to whether the identity provider supports Sigma enrollment. (Block 710). This may be accomplished, for example, based on sending the S1 message in FIG. 10.

If the identity provider does not support Sigma enrollment, then control passes to Block 570. On the other hand, if the identity provider is determined to support Sigma enrollment, then a Sigma session is opened in the identity provider. (Block 720). Opening of the Sigma session may involve transmitting the S1 message in FIG. 10. According to one embodiment, the first message is send based on a signed Diffie-Hellman key exchange protocol, also referred to as Sigma.

Also, in FIG. 10, the verifier, prover, and Online Certificate Status Protocol (OSCP) responder may correspond to any combination of the identity provider, identity requester, and electronic device. Also, according to one example, the prover may be regarded as corresponding to a client-side of the Sigma protocol and the verifier may be regarded as corresponding to a server side of the Sigma protocol. Using the Sigma protocol allows the prover to verify the verifier identity (so, for example, the client knows which domain it is interacting with. The server can verify that the client (e.g., prover) is a trustworthy environment (e.g., a secure element).

Also, in one embodiment, OSCP responder may operate as a third entity supplying revocation list information. The third entity may be, for example, a certificate authority that has its public key embedded in the prover hardware to allow for verification of the verifier's certificate and the certificate authority's revocation list(s). The S2 and S3 messages are exchanged between the prover and verifier to allow for identity verification after receipt of the response message from the OCSP responder.

After the Sigma session has been opened, the requested credentials stored in a server (or elsewhere) of the identity provider are encrypted using a predetermined key. (Block 730). Encryption may be performed, for example, based on the Sigma session key (SK) using a symmetric key cipher such as Advanced Encryption Standard (AES) or Triple Data Encryption Standard (3DES). The Sigma key may be a private key corresponding to the user or another type of key.

Once encrypted, the credentials are transferred from the identity provided to the identity requester along the OTA connection. (Block 740). This operation may be performed based on one or more predetermined enrollment protocols corresponding to the opened Sigma session. The process of disclosing credentials to the identity requester may be considered to constitute the enrollment protocol. In this regard, a management engine (or other secure element) in the identity provider (or alternatively the management engine in the identity requester) may perform the role of trusted authority that vouches for the authenticity of the credentials. In PKI terminology, the management engine may be considered in this case to be a registration authority.

The encrypted credentials are decrypted by the management engine, and then this engine establishes the second user identity based on the credentials. (Block 750). The decryption is performed based on the predetermined key and technique used for encryption, which information may be notified to the identity requester during the Sigma session where the MK (master key) and SK keys are sent in one or more of the exchanged messages shown, for example, in FIG. 10.

The second user identity may be established by one or more credentials (including any of those previously mentioned, e.g., name, account numbers, etc.) which have a high probability of uniquely identifying a user. An example of operations performed to establish the second identity may include:
1. Obtaining the credentials of the user
2. Vetting the correctness and/or relevance to the user performed, for example, by a trusted authority such as a registration authority. In so doing, the management engine of the identity requester leverages a previously issued identity from another service provider to get correctness and relevance.
3. Present the credentials to a domain authority, which associates domain specific credentials or other attributes (e.g., names, numbers, roles, privileges) that are controlled by the domain naming authority. For example, the .com domain is controlled by the Internet Attribute and Naming Authority (IRNA).

The domain authority may issue the credential(s) corresponding to the second user identity, for example, by signing a certificate or by creating an entry in a database controlled by the relevant domain, e.g., domain of the identity requester. In this example, the management engine of the identity provider may perform the role of a domain for the user. Because the management engine is trusted by other domains (e.g., identity requester) to properly negotiate attributes, it enables over-the-air construction of credentials automatically, without manual intervention.

Essentially, this identity provides an indication to the identity provider that the subscription or service sought by the user is authorized for the user, for example, to be received on the user's mobile or other device. As shown in FIG. 1, the mobile device may be coupled to the identity provider through an over-the-air link or another type of link. By establishing the second user identity in a manner transparent to the user, based on an identity already established for the user by another entity/identity provider, the process of authenticating and authorizing receipt of a subscription/service is made to be efficient compared with other manual-based methods.

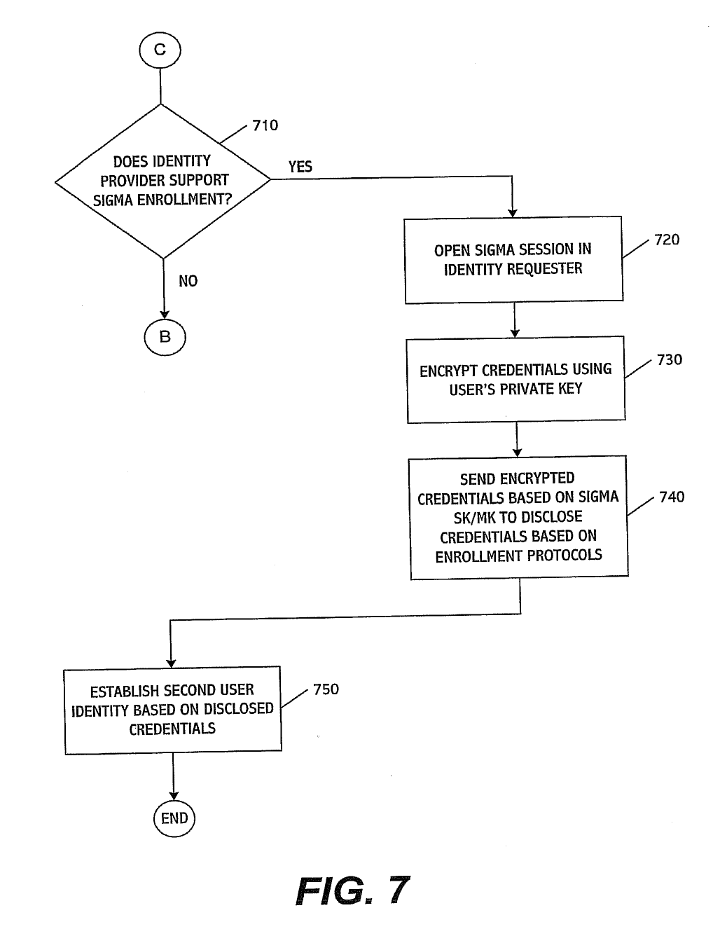

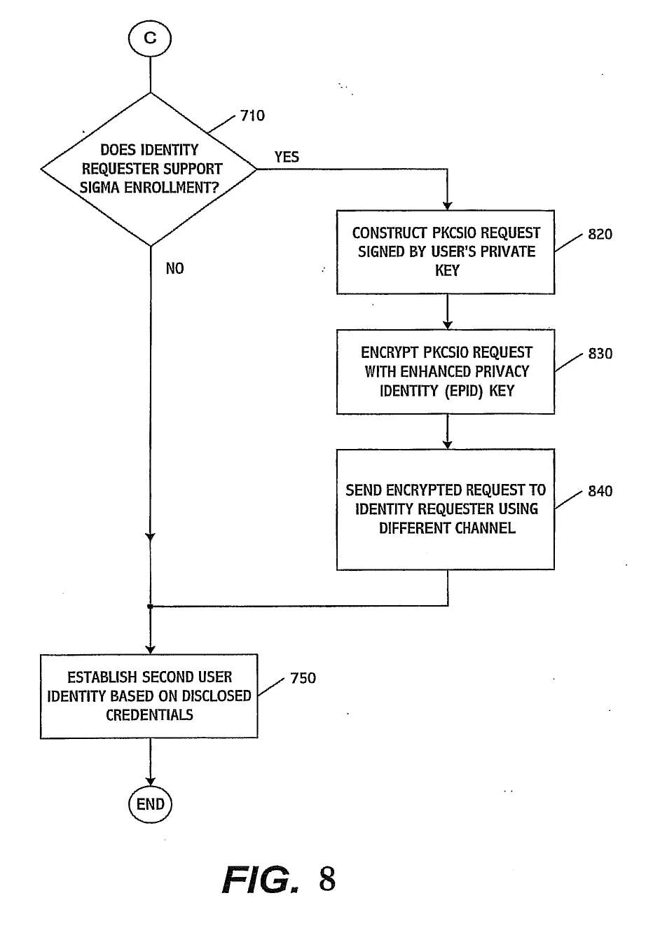

As an alternative to the operations in Blocks 720, 730, and 740 in FIG. 7, the operations in FIG. 8 may be performed. These operations include constructing a public-key cryptography standard (PKCS) request signed by a predetermined key. (Block 820). The PKCS request may correspond to the PCKS 10 standard, which constitutes a certification request. More specifically, PCKS 10 corresponds to a format of messages sent to a certification authority to request certification of a key. The key may be a public or private key, and in the latter case may correspond to the private key of the user of mobile device 10.

Once the PCKS request has been constructed, the request may be encrypted, or signed, with an Enhanced Privacy Identity (EPID) key. (Block 830). EPID is a cryptography protocol that provides proof of identity (or membership in a group) in an anonymous manner. In accordance with this protocol, the entity issuing the EPID does not store the private keys of users in a database, and the EPID key is revocable should the user's private key be revealed.

More specifically, EPID employs a direct anonymous attestation scheme with enhanced revocation abilities, which provides an enhanced measure of protection for the user. Unlike other methods, in EPID, no one can open a group signature to determine the signers. Moreover, EPID can be used for authentication as well as attestation, while simultaneously preserving the privacy of the user.

Once the PCKS request has been encrypted with an EPID key, it is sent to the identity requester. (Block 840). The request may be send along the OTA connection or a different connection. Because of the enhanced protection provided by EPID, security of the request remains in tact. The identity requester may then establish the second user identity as in Block 750.

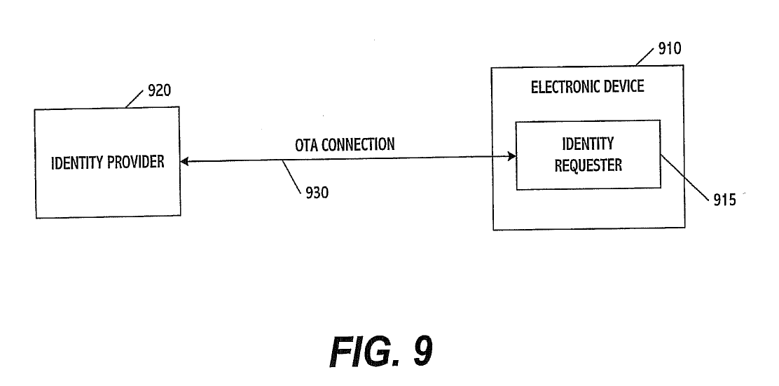

FIG. 9 shows another embodiment of a system which for performing OTA identity provisioning, in which the identity requester is located within the electronic device. In this embodiment, the identity requester 915 is located within the user's electronic device 910, which, for example, may be a mobile device or any of the other devices previously described. The identity requester may operate in a manner similar to the identity requester previously described for purposes of obtaining identity credentials and other operations interactively performed with identity provider 920. The identity provider and identity requester/device may communicate with one another over OTA connection 930.

In accordance with another embodiment, the electronic device is omitted and the identity requester is to establish an identity for a user based on the identity previously established by the identity provider. Such an embodiment may cover, for example, the case where the identity requester is a point-of-sale (POS) terminal, a ticket terminal or automated teller machine, the control system of a gas station pump, a security system for an office, building or home, parking validation or payment machine, or other types of systems or devices that require user authentication and identity confirmation.

Another embodiment corresponds to a computer-readable medium storing a program including code sections for performing operations of the methods previously described. A first computer-readable medium may be located in the identity requester storing code for performing the operations of the management engine and its associated features. A second computer-readable medium may be located in the identity provider for storing code to perform the operations of the identity provider as previously explained. A third computer-readable medium may be located in the device for performing operations for requesting and/or receiving services as described herein.

Any reference in this specification to an “embodiment” means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. Also, the features of any one embodiment described herein may be combined with the features of one or more other embodiments to form additional embodiments.

Furthermore, for ease of understanding, certain functional blocks may have been delineated as separate blocks; however, these separately delineated blocks should not necessarily be construed as being in the order in which they are discussed or otherwise presented herein. For example, some blocks may be able to be performed in an alternative ordering, simultaneously, etc.

Although the present invention has been described herein with reference to a number of illustrative embodiments, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

We claim:

1. An apparatus comprising:
an interface to be coupled to an over-the-air (OTA) link;
a storage area to store data corresponding to a first identity of a user; and
a processor to establish a second identity of the user based on the data to be stored in the storage area corresponding to the first identity, wherein the data corresponding to the first identity is to be received through the interface during a secure protocol session and wherein the first identity is to be established for a first service and the second identity is to be established for a second service, the first and second services to be received by an electronic device of the user.

2. The apparatus of claim 1, wherein the apparatus is included in the device.

3. The apparatus of claim 1, wherein the apparatus and device communicate over a wireless link.

4. The apparatus of claim 1, wherein the device is a mobile communication device.

5. The apparatus of claim 1, wherein the data corresponding to the first identity of the user is to be received in an encrypted signal.

6. The apparatus of claim 5, wherein the encrypted signal is encrypted with an enhanced privacy identification (EPID) key.

7. The apparatus of claim 1, wherein the data corresponding to the first identity includes a plurality of credentials of the user.

8. The apparatus of claim 7, wherein the processor is to:
receive a request for one or more required credentials,
compare the plurality of credentials to be stored in the storage area to the one or more required credentials, and
establish the second identity of the user if the one or more required credentials are included in the plurality of credentials to be stored in the storage area.

9. The apparatus of claim 8, wherein the processor is to:
obtain data corresponding to an identity of the user from another source if all of the one or more required credentials are not included in the plurality of credentials to be stored in the storage area.

10. The apparatus of claim 1, wherein the data corresponding to the first identity of the user is to be received based on a public-key cryptography standard (PKCS) signal.

11. An apparatus comprising:
an interface to be coupled to an over-the-air (OTA) link;
a storage area to store data corresponding to an identity of a user; and
a controller to receive a request signal from the OTA link, compare information in the request signal for identity data to the data corresponding to the identity in the storage area, is and send the data corresponding to the identity of the user from the storage area to the OTA link based on the comparison, wherein the data corresponding to the identity of the user is to be sent over the OTA link during a secure protocol session performed for the apparatus.

12. The apparatus of claim 11, wherein the controller is to block sending the data in the storage area when the comparison indicates that all of the information for identity data in the request signal is not included in the data in the storage area.

13. The apparatus of claim 11, wherein the controller is to send the data in the storage area when the comparison indicates that all of the information for identity data in the request signal is included in the data in the storage area.

14. The apparatus of claim 11, wherein the data to be stored in the storage area includes:
one or more identity credentials of a first priority, and
one or more identity credentials of a second priority different from the first priority.

15. The apparatus of claim 14, wherein:
the first priority corresponds to publicly available credentials, and
the second priority corresponds to private credentials of the user.

16. The apparatus of claim 14, wherein the information for identity data in the request signal is to include one or more identity credentials of the user, and wherein the controller is to:
compare the one or more identity credentials in the request signal to authorization data stored in a memory, the authorization data to indicate that the user has given permission to disclose credentials of the first priority and not disclose credentials of the second priority, and
prevent sending the data corresponding to the identity of the user stored in the storage area when the comparison indicates that at least one of the identity credentials in the o request signal is of the second priority.

17. The apparatus of claim 11, wherein the controller is to send the data corresponding to the identity of the user from the storage area to the OTA link in an encrypted form based on an enhanced privacy identification (EPID) key.

18. A method for controlling access to information, comprising:
sending a request to an identity provider through an over-the-air (OTA) link;
receiving data from the identity provider after the request is sent, the data from the identity provider corresponding to a first identity of a user; and
establishing a second identity of the user based on the data received from the identity provider, wherein the data corresponding to the first identity is to be received during a secure protocol session, wherein the first identity is established by the identity provider for a first service, and wherein the second identity is established to receive a second service, the first and second services to be received by an electronic device of the user.

19. The method of claim 18, wherein at least said receiving and establishing is performed by an identity requester, and wherein the identity requester is to provide the second service.

20. The method claim 18, wherein at least said receiving and establishing is performed by an identity requester, and wherein the identity requester is included in the electronic device.

21. The method of claim 20, wherein the device is a mobile communication device.

22. The method of claim 18, wherein the data from the identity provider is received in an encrypted signal.

23. The method of claim 22, wherein the encrypted signal is encrypted with an enhanced privacy identification (EPID) key.

24. The method of claim 18, wherein the request includes information identifying one or more identity credentials to be received from the identity provider for establishing the second identity based on the first identity.

25. The method of claim 18, wherein at least one of the first service or the second service is based on a subscription.

26. A method for controlling access to information, comprising;
storing identity data corresponding to a user;
receiving a request for identity data of the user;
comparing identity data in the request to the stored identity data; and
sending the stored identity data to an identity requester based on the comparison,
wherein the request is received from the identity requester and the stored data is sent to the identity requester an over-the-air (OTA) link and wherein the stored data is sent through the OTA link during a secure protocol session.

27. The method of claim 26, wherein the stored identity data is sent to the identity requester when all the identity data in the request is included in the stored identity data.

28. The method of claim 26, wherein the stored identity data is not sent to the identity requester when all the identity data in the request is not included in the stored identity data.

29. The method of claim 26, wherein the stored data includes a first identity credential of a first priority and a second identity credential of a second priority, and wherein the stored identity data is not sent to the identity requester when authorization has not been given by the user to disclose second priority credentials.

30. The method of claim 26, wherein the stored identity data is sent in a signal encrypted with an enhanced privacy identification (EPID) key.
